(19) United States
(12) Patent Application Publication
(10) Pub. No.: US 2016/0027214 A1
(43) Pub. Date: Jan. 28, 2016

(54) MOUSE SHARING BETWEEN A DESKTOP AND A VIRTUAL WORLD

(71) Applicants: Robert Memmott, Bellevue, WA (US); Ben Sugden, Redmond, WA (US); Tom Salter, Seattle, WA (US)

(72) Inventors: Robert Memmott, Bellevue, WA (US); Ben Sugden, Redmond, WA (US); Tom Salter, Seattle, WA (US)

(21) Appl. No.: 14/628,539

(22) Filed: Feb. 23, 2015

Related U.S. Application Data
(60) Provisional application No. 62/029,351, filed on Jul. 25, 2014.

(51) Int. Cl. G06T 19/00; G06F 3/0354; G02B 27/01

(52) U.S. Cl. CPC G06T 19/006; G02B 27/0172; G06F 3/03543; G02B 2027/0178

(57) ABSTRACT

A mixed-reality head mounted display (HMD) device supports a three dimensional (3D) virtual world application with which a real world desktop displayed on a monitor coupled to a personal computer (PC) may interact and share mouse input. A mouse input server executing on the PC tracks mouse movements on the desktop displayed on a monitor. When movement of the mouse takes it beyond the edge of the monitor screen, the mouse input server takes control of the mouse and stops mouse messages from propagating through the PC's system. The mouse input server communicates over a network connection to a mouse input client exposed by the application to inform the client that the mouse has transitioned to operating in the virtual world and passes mouse messages describing movements and control operation such as button presses.

### STATEMENT OF RELATED APPLICATIONS

This application claims benefit and priority to U.S. Provisional Application Ser. No. 62/029,351 filed Jul. 25, 2014, entitled “Head Mounted Display Experiences” which is incorporated herein by reference in its entirety.

### BACKGROUND

Mixed reality computing devices, such as head mounted display (HMD) systems and handheld mobile devices (e.g. smart phones, tablet computers, etc.), may be configured to display information to a user about virtual and/or real objects in the field of view of the user and/or a field of view of a camera of the device. For example, an HMD device may be configured to display, using a see-through display system, virtual environments with real world objects mixed in, or real world environments with virtual objects mixed in. Similarly, a mobile device may display such information using a camera viewfinder window.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A mixed-reality head mounted display (HMD) device supports a three dimensional (3D) virtual world application with which a real world desktop displayed on a monitor coupled to a personal computer (PC) may interact and share mouse input. A mouse input server executing on the PC tracks mouse movements on the desktop displayed on a monitor. When movement of the mouse takes it beyond the edge of the monitor screen, the mouse input server takes control of the mouse and stops mouse messages from propagating through the PC's system. The mouse input server communicates over a network connection to a mouse input client exposed by the application to inform the client that the mouse has transitioned to operating in the virtual world and passes mouse messages describing mouse movements and control operation such as button presses. The mouse input client calculates an initial position of the mouse in the virtual world using the last location on the desktop and utilizes the mouse messages to calculate position deltas to dynamically control the mouse in the virtual world based on movements of the mouse and control inputs from the user.

In various illustrative and non-limiting examples, the HMD device can support a mixed-reality environment in which the user sees and interacts with a desktop shown on the monitor using the mouse. The user can seamlessly transition the mouse into the virtual world to interact with virtual world objects with a cursor that is dynamically rendered in 3D using a size that is proportional to the cursor's distance from the user in the virtual world (i.e., it is bigger when closer and smaller when farther away). In some scenarios, the user can drag a window or other object from the desktop into the virtual world to create a virtual object such as a slate, canvas, or interactive object. In other scenarios, the user can employ the mouse to interact with real world objects that may be included as part of the mixed-reality environment. For example, the user can move the mouse cursor to collide with a real world object and click on/select a real world surface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Furthermore, the claimed subject matter is not limited to implementations that solve any or all disadvantages noted in any part of this disclosure. It may be appreciated that the above-described subject matter may be implemented as a computer-controlled apparatus, a computer process, a computing system, or as an article of manufacture such as one or more computer-readable storage media. These and various other features may be apparent from a reading of the following Detailed Description and a review of the associated drawings.

### DESCRIPTION OF THE DRAWINGS

FIG. 1 shows an illustrative virtual reality environment, a portion of which is rendered within the field of view of a user of an HMD device;

FIG. 2 shows an illustrative real world environment in which a user of an HMD device is located;

FIG. 3 shows an illustrative mixed reality environment displayed within a field of view of an HMD device;

FIG. 4 shows illustrative data provided by an HMD sensor package;

FIG. 5 depicts surface reconstruction data associated with real world objects being captured by an HMD device;

FIG. 6 shows a block diagram of an illustrative surface reconstruction pipeline;

FIG. 7 shows a three dimensional (3D) virtual application supporting a mouse input client that communicates over a network connection with a mouse input server executing on a personal computer (PC);

FIG. 8 shows an illustrative method that may be implemented using a mouse input client and mouse input server;

FIG. 9 shows a mouse cursor being illustratively transitioned from a desktop to a position in a virtual world in a mixed-reality environment displayed within the field of view of a user of an HMD device;

FIG. 10 shows an object being dragged using a mouse from a desktop into a virtual world in a mixed-reality environment displayed within the field of view of a user of an HMD device;

FIG. 11 shows a mouse cursor colliding with a real world object in a mixed-reality environment displayed within the field of view of a user of an HMD device;

FIGS. 12, 13, and 14 are flowcharts of illustrative methods that may be performed using an HMD device;

FIG. 15 is a pictorial view of an illustrative example of a virtual reality HMD device;

FIG. 16 shows a functional block diagram of an illustrative example of a virtual reality HMD device;

FIGS. 17 and 18 are pictorial front views of an illustrative sealed visor that may be used as a component of a virtual reality HMD device;

FIG. 19 shows a view of the sealed visor when partially disassembled;

FIG. 20 shows a phantom line front view of the sealed visor;

FIG. 21 shows a pictorial back view of the sealed visor;

FIG. 22 shows an exemplary computing system; and

FIG. 23 is a simplified block diagram of an illustrative computer system such as a personal computer (PC) that may be used in part to implement the present mouse sharing.

Like reference numerals indicate like elements in the drawings. Elements are not drawn to scale unless otherwise indicated.

### DETAILED DESCRIPTION

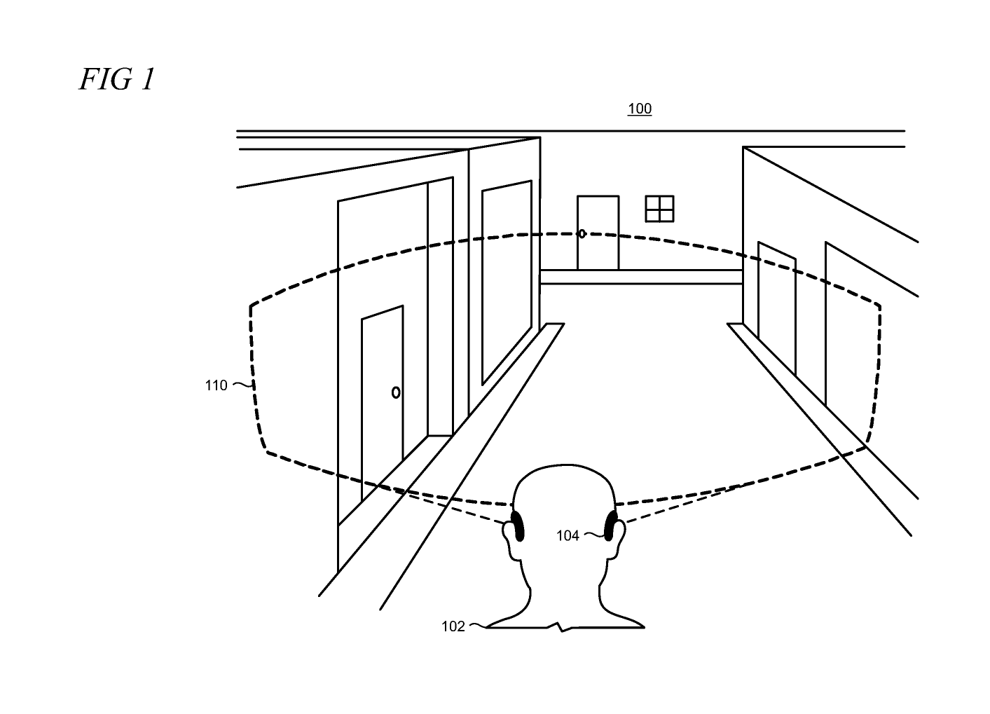

A mixed reality or augmented reality environment supported on an HMD device typically combines real world elements and computer-generated virtual reality elements to enable a variety of user experiences. In an illustrative example, as shown in FIG. 1, a user 102 can employ an HMD device 104 to experience a virtual reality environment 100 that is rendered visually on an optics display and may include audio and/or tactile/haptic sensations in some implementations. In this particular non-limiting example, the virtual reality environment 100 includes city streets with various buildings, stores, etc. that the user 102 can see and interact with. As the user changes the position or orientation of his head and/or moves within real world space, his view of the virtual reality environment can change. The field of view (represented by the dashed area 110 in FIG. 1) can be sized and shaped and other characteristics of the device can be controlled to make the HMD device experience visually immersive to provide the user with a strong sense of presence in the virtual world.

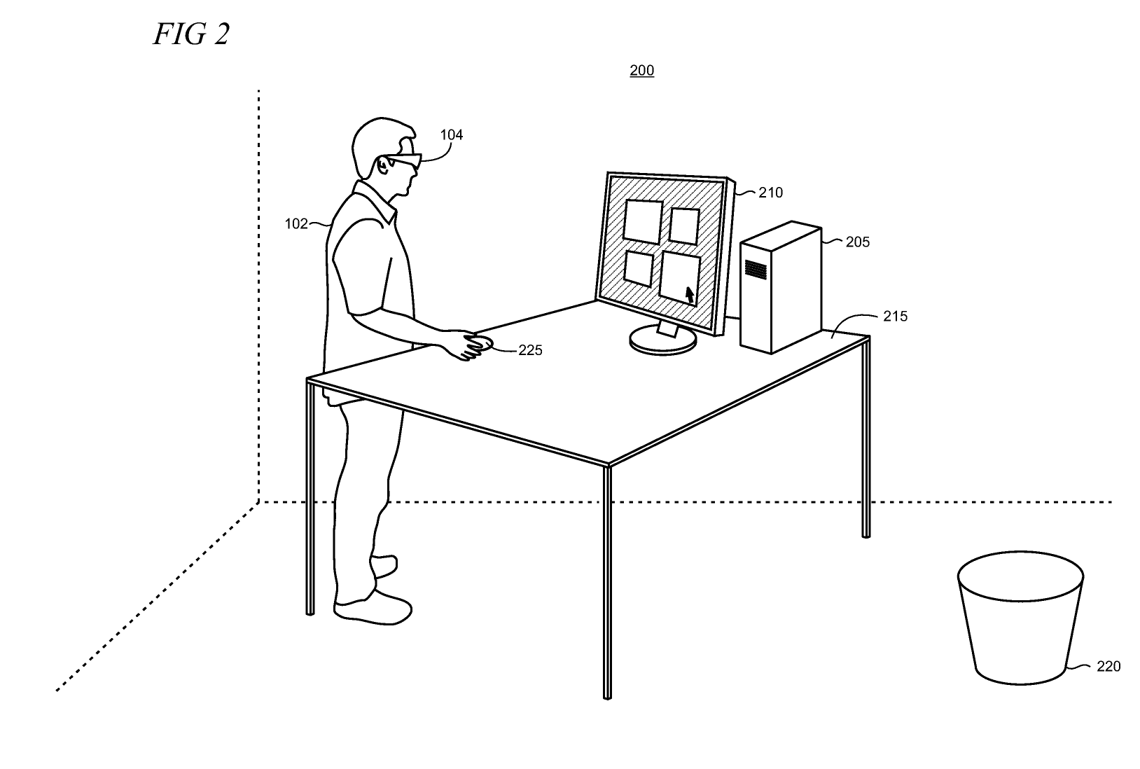

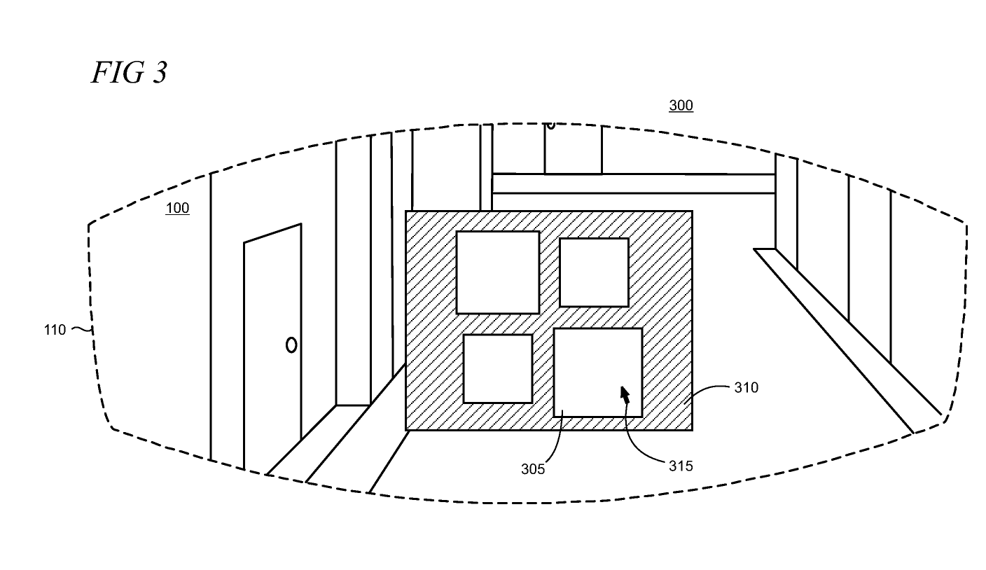

As shown in FIG. 2, the physical, real world space 200 that the user occupies when using the HMD device 104 can contain various real world objects including a PC 205, monitor 210, and work surface 215. Other real world objects may also be present in the space 200 as representatively indicated by reference numeral 220. The user may interact with the PC and monitor using a mouse 225 and other user interfaces (not shown in FIG. 2) such as keyboards, voice, and gestures in some cases. In this particular illustrative example, the monitor is incorporated into a mixed reality environment 300, as shown in FIG. 3, and may be visible to the user on the HMD device 104.

The user can typically interact with the PC when viewing the monitor 210 in the mixed-reality environment in substantially the same way as in the real world environment. For example, the user can interact with objects, elements, windows, etc., (representatively indicated by reference numeral 305) that are supported on the desktop 310 using a mouse cursor 315 that is displayed on the monitor 210.

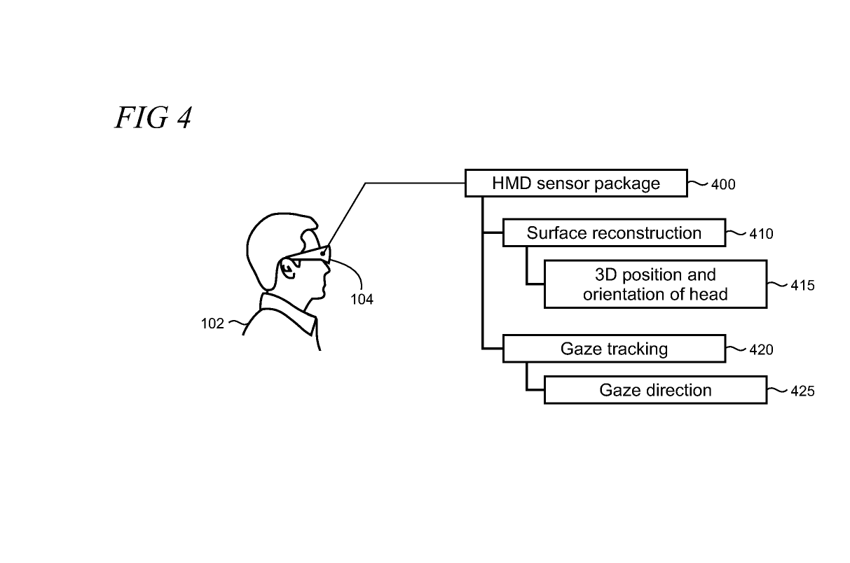

As shown in FIG. 4, the HMD device 104 is configured with a sensor package 400. Exemplary sensors are described in more detail below. The sensor package 400 can support various functionalities including surface reconstruction 410 that may be used for head tracking to determine the 3D (three-dimensional) position and orientation 415 of the user's head within the physical real world space 200. In some implementations, the sensor package can support gaze tracking 420 to ascertain a direction of the user's gaze 425 which may be used along with the head position and orientation data when implementing the present mouse sharing.

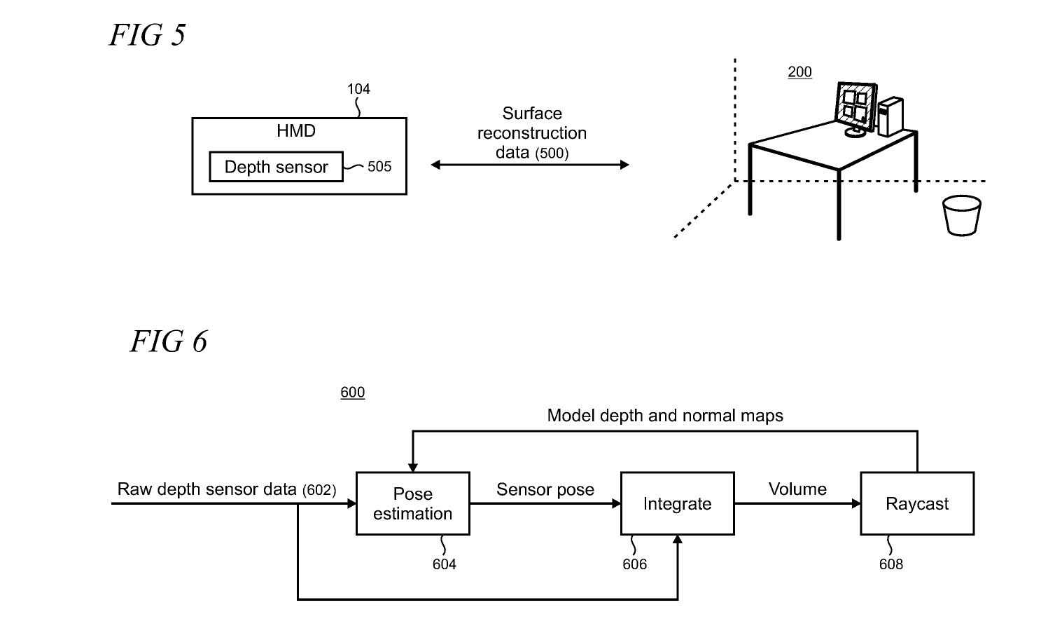

The HMD device 104 is configured to obtain surface reconstruction data 500 by using the sensor package that includes an integrated depth sensor 505, as shown in FIG. 5, in order to perform head tracking In alternative implementations, depth data can be derived using suitable stereoscopic image analysis techniques. FIG. 6 shows an illustrative surface reconstruction data pipeline 600 for obtaining surface reconstruction data for objects in the real world space. It is emphasized that the disclosed technique is illustrative and that other techniques and methodologies may be utilized depending on the requirements of a particular implementation. Raw depth sensor data 602 is input into a 3D (three-dimensional) pose estimate of the sensor (block 604). Sensor pose tracking can be achieved, for example, using ICP (iterative closest point) alignment between the predicted surface and current sensor measurement. Each depth measurement of the sensor can be integrated (block 606) into a volumetric representation using, for example, surfaces encoded as a signed distance field (SDF). Using a loop, the SDF is raycast (block 608) into the estimated frame to provide a dense surface prediction to which the depth map is aligned. Thus, when the user 102 looks around the virtual world, surface reconstruction data associated with the real world space 200 (FIG. 2) can be collected and analyzed to determine the user's head position and orientation within the space. Along with gaze detection in some implementations, the head tracking enables the HMD device 104 to ascertain the user's view position.

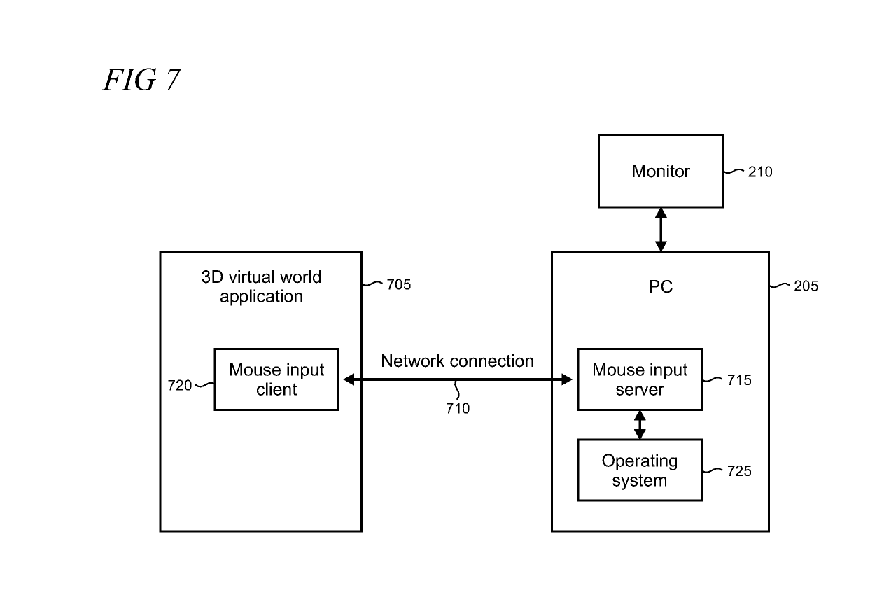

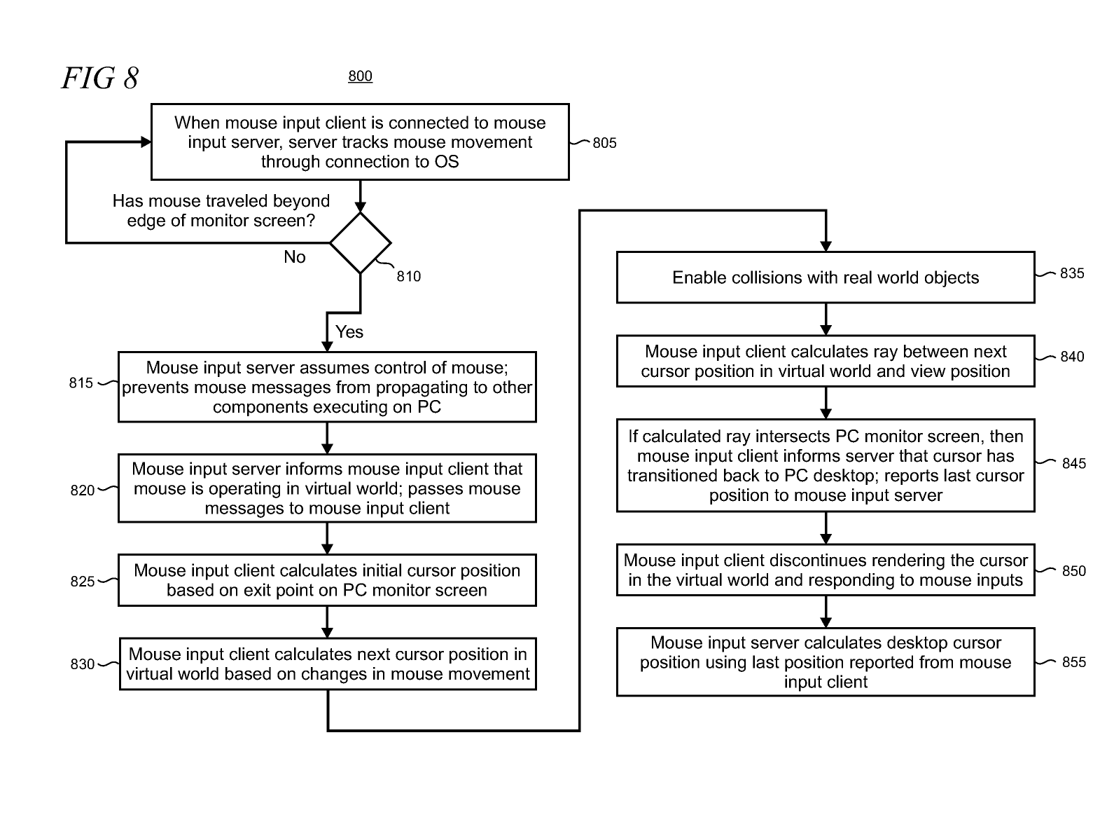

The HMD device 104 may utilize a 3D virtual world application 705 to support the mixed reality environment, as shown in FIG. 7. The application can communicate over a network connection 710 with the PC 205. The PC 205 exposes a mouse input server 715 that interacts with a client 720 that is supported by the application 705. The mouse input server interfaces with the operating system (OS) 725 running on the PC to listen to mouse inputs from the user. FIG. 8 is a flowchart of an illustrative method 800 that may be implemented using the mouse input server and client.

In step 805, when the mouse input client 720 is connected to the mouse input server 715 on the PC 205, the mouse input server tracks mouse movement through its connection with the operating system 725. At decision block 810, if the mouse has not traveled beyond the limits of the screen of the monitor 210, then it is assumed that the user is still using the mouse on the desktop and control returns to step 805. If the mouse has traveled beyond the extent of the monitor, then in step 815 the mouse input server 715 assumes control of the mouse and prevents mouse messages from propagating to other components executing on the PC 205.

In step 820, the mouse input server 715 informs the mouse input client 720 that the mouse is operating in the virtual world and it passes mouse messages such as mouse movements and user inputs (e.g., button clicks, scroll wheel actions, etc.) to the mouse input client. The mouse input client 720 calculates an initial position for the cursor 315 in the virtual world based on exit point on the screen of the monitor 210 in step 825, and computes the next position for the cursor 315 based on changes in mouse movement in step 830. The cursor may be dynamically rendered in 3D using a size that is proportional to the cursor's distance from the user in the virtual world. That is, it is typically rendered to be bigger when it closer to the viewer in the virtual world and smaller when it is farther away. Such dynamic rendering according to distance can be beneficial as the user does not need to change his focal depth when looking at the cursor and any surrounding elements or objects in the virtual world. Collisions may be enabled in step 835 so that the user can click on surfaces of real world objects in the mixed reality environment in some cases, as described in more detail below.

In step 840, the mouse input client 720 calculates a ray between the next cursor position in the virtual world and the view position associated with the HMD device 104. If the calculated ray intersects the screen of the monitor 210, then the mouse input client 720 informs the mouse input server 715 that the cursor 315 has transitioned back to the PC desktop in step 845 and reports the last cursor position to the mouse input server. The mouse input client 720 discontinues rendering the cursor 315 in the virtual world and stops responding to mouse input events in step 850. The mouse input server 715 calculates the cursor reentry position on the desktop using the last position reported by the mouse input client 720 in step 855.

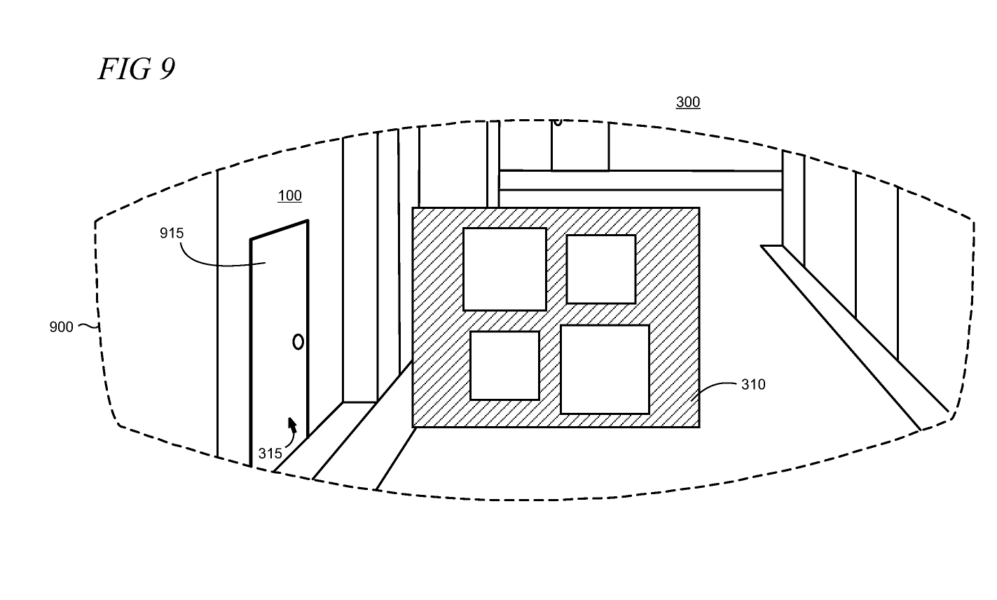

FIGS. 9, 10, and 11 show illustrative examples of mouse sharing between the PC desktop and the virtual world. It is emphasized that the examples are intended to be illustrative and that a wide variety of different mouse sharing scenarios can be implemented using the present techniques.

FIG. 9 shows an illustrative field of view 900 provided by the HMD device 104 when the cursor 315 has transitioned off the desktop 310 and into the virtual world 100. As shown in this particular example, the user has moved the cursor 315 to click on a door 915 in the virtual world 100. As noted above, the cursor 315 can be proportionally rendered in 3D in the virtual world (the depiction of the cursor in the drawings is simplified to aid in clarity of exposition).

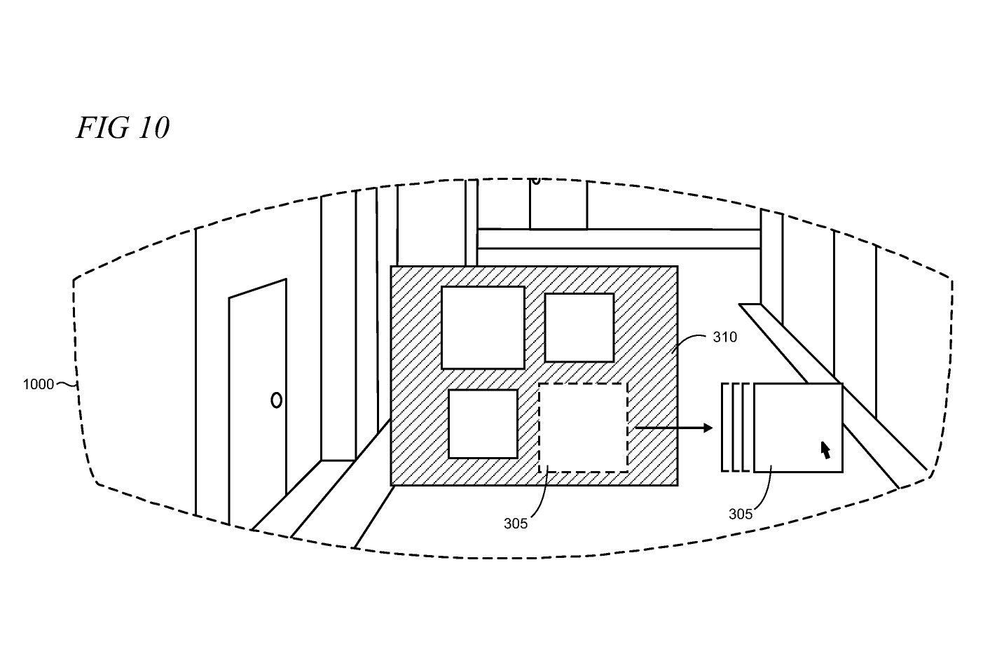

FIG. 10 shows an illustrative field of view 1000 that shows the user dragging the object 305 from the desktop 310 into the virtual world using the mouse. In some cases, the object can behave as it normally does when supported by the desktop after being dragged into the virtual world. For example, if the object 305 is an application window, the application from the PC can render into the window in a normal manner. This feature can thus enable the user to expand the size of the desktop. In other cases, the behavior of the object can be transformed when it is dragged into the virtual world (where such transformed behaviors can be implemented according to the needs of a particular implementation). In this particular example, the object 305 functions as a slate or canvas to provide additional work area for the user.

When the user moves an object from the desktop to the virtual world in some cases, it can be fixed at its location until the user moves it again. For example, if the user drags and places the object in a location in the virtual world that is adjacent to the monitor 210, it may become outside the user's field of view when the user turns his head to look at another part of the virtual world. In other cases, the dragging action can be used to fix or clip the desktop object to a portion of the field of view so that the object remains visible regardless of the user's head position/orientation or the user's location within the virtual world.

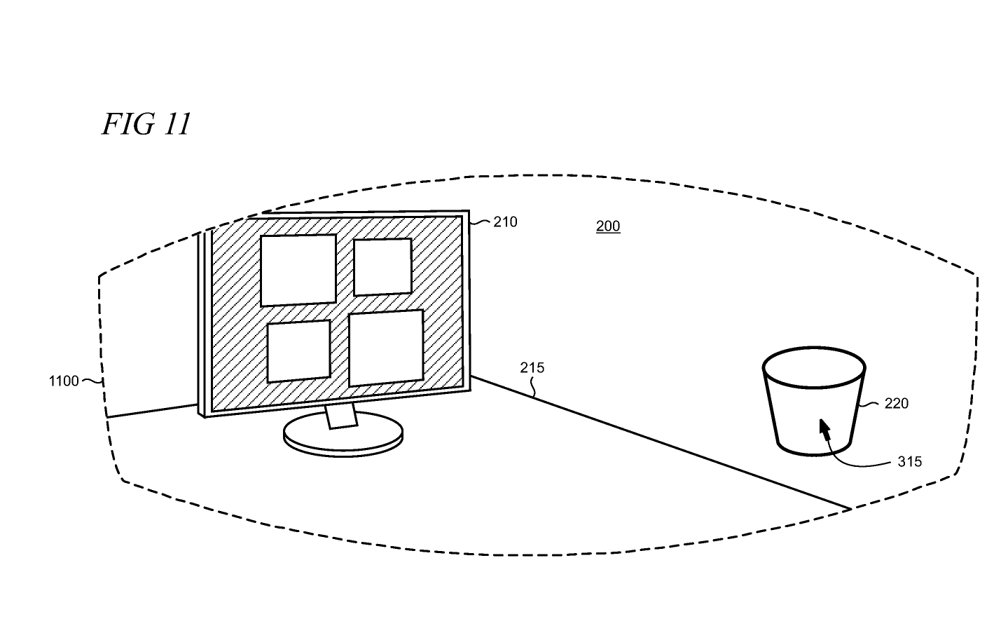

FIG. 11 shows an illustrative field of view 1100 in which the HMD device 104 is configured to enable portions of the physical space 200 (FIG. 2) to be viewable. The user can see the monitor 210, the work surface 215 and other parts of the space 200 such as the floor, walls, etc. The wastebasket object 220 is also in the field of view 1100. The HMD device 104 provides the user with the capability to move the cursor to collide with real world objects (for example the object 220 as shown) so as to interact with the real world object, click on a surface, make a selection, point to the object, and the like. In some scenarios, the HMD device 104 can be configured to apply various visual treatments to a real world object responsively to mouse interactions such as highlights, colors, animations, or other holographic or virtual elements/objects.

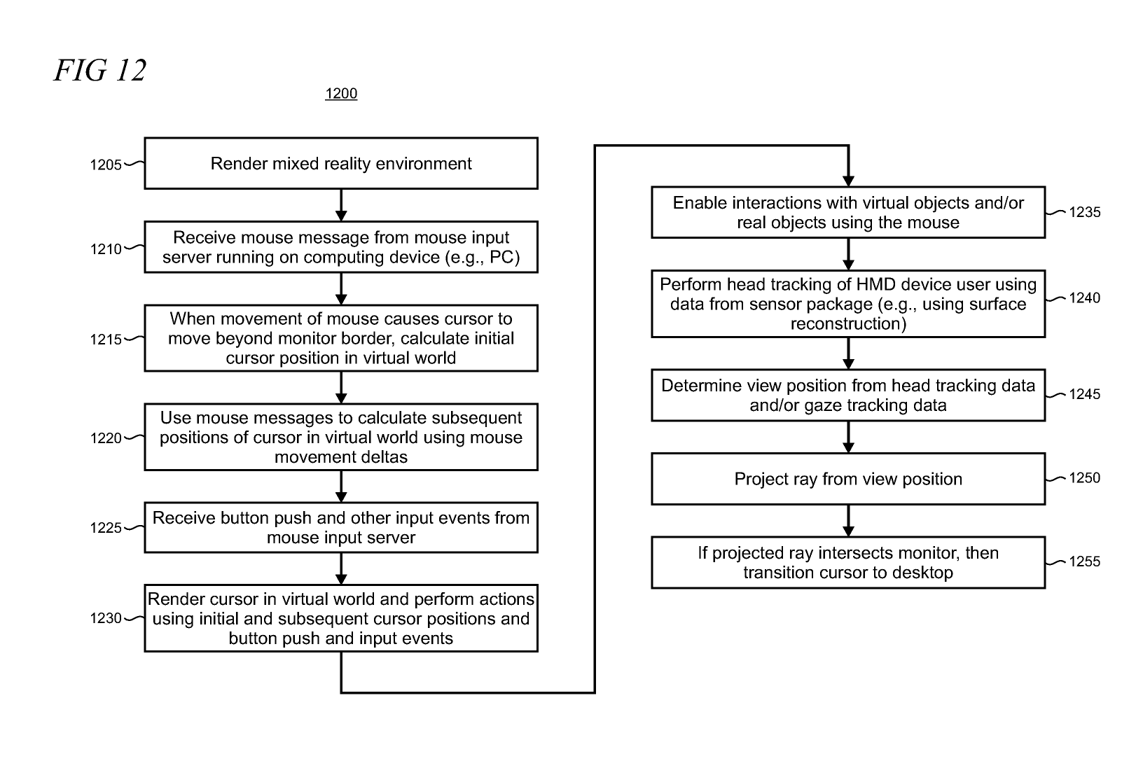

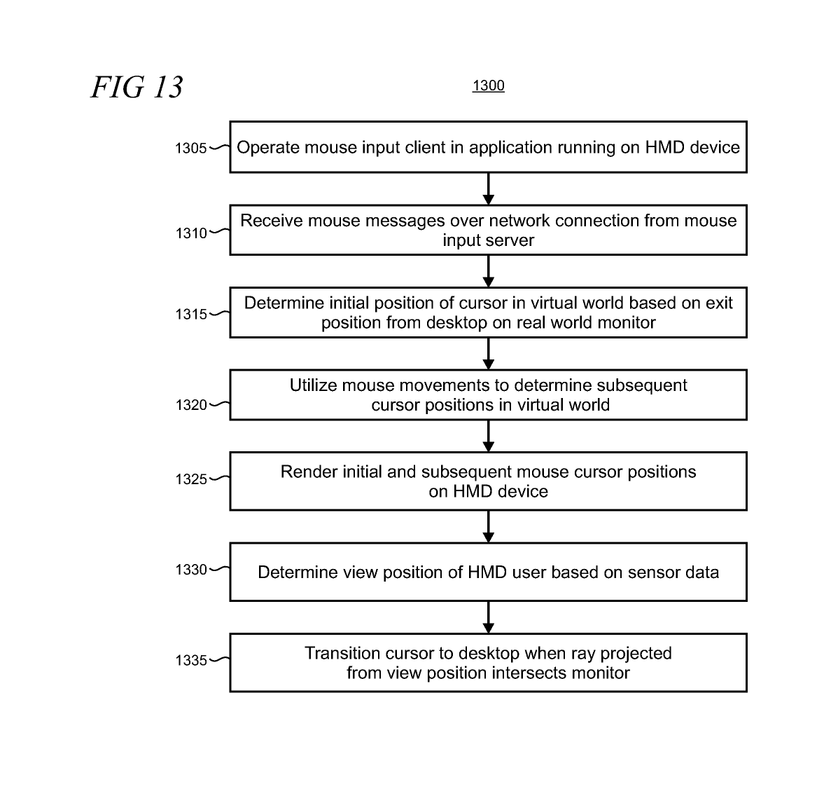

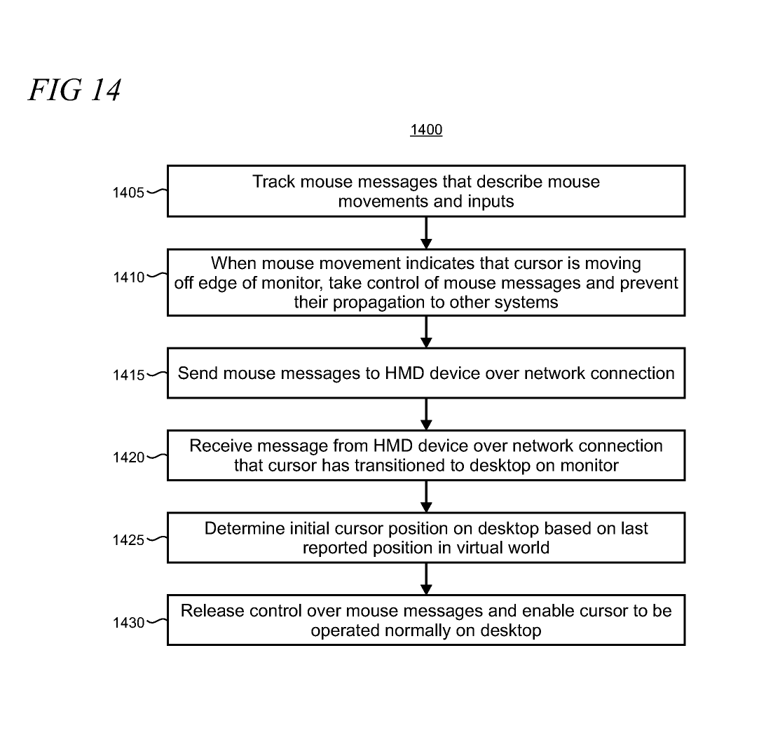

FIGS. 12 and 13 are flowcharts of illustrative methods that may be performed using the HMD device 104. FIG. 14 is a flowchart of an illustrative method that may be performed by a computing device such as PC 205. Unless specifically stated, the methods or steps shown in the flowcharts and described in the accompanying text are not constrained to a particular order or sequence. In addition, some of the methods or steps thereof can occur or be performed concurrently and not all the methods or steps have to be performed in a given implementation depending on the requirements of such implementation and some methods or steps may be optionally utilized.

In the illustrative method 1200 shown in FIG. 12, in step 1205 the HMD device renders a mixed reality environment that typically includes objects in a virtual world and real world objects such as the monitor 210. In step 1210, mouse messages are received over a network connection from the mouse input server operating on a remote computing device such as PC 205. When movement of the mouse causes the cursor to move beyond the monitor's border, in step 1215, an initial cursor position in the virtual world is calculated. In step 1220, the mouse messages are utilized to determine subsequent cursor positions based on deltas in the mouse movement. In step 1225, button pushes and other input events are received from the mouse input server.

In step 1230, the cursor is rendered in the virtual world and actions are performed (e.g., selecting, dragging, scrolling, etc.) using the initial and subsequent positions and the button push and input events. In step 1235, interactions with virtual objects and/or real world objects are supported using the mouse.

In step 1240, head tracking is performed using data from a sensor package, for example using surface reconstruction techniques. Gaze tracking may also be performed in some cases. In step 1245, a view position is determined from head tracking data and/or gaze tracking data. A ray is projected from the view position in step 1250 and if the projected ray intersects the monitor, then in step 1255 the cursor is transitioned to the desktop on the monitor.

In the illustrative method 1300 shown in FIG. 13, a mouse input client is operated in an application that runs on the HMD device in step 1305. In step 1310, mouse messages are received over a network connection from a mouse input server that runs on a computing device such as PC 205. In step 1315, an initial position of the cursor is determined based on an exit position from the desktop supported on the monitor 210. Mouse movements are utilized to determine subsequent cursor positions in the virtual world in step 1320. The initial and subsequent cursor positions are rendered on the HMD device in step 1325. A view position is determined in step 1330 using sensor data from the sensor package on the HMD device. The cursor is transitioned to the desktop when a ray projected from the view position intersects the monitor in step 1335.

In the illustrative method 1400 shown in FIG. 14, a mouse input server running on a computing device such as PC 205 tracks mouse messages that describe mouse movements and inputs in step 1405. For example, the mouse input server can have hooks into an operating system running on the computing platform in order to track the mouse messages. If no mouse input client is detected, then the mouse input server typically just listens to the mouse messages but takes no other actions. When the client is connected over the network connection, then the mouse input server can perform the tracking In step 1410, when the mouse movement indicates that the cursor is moving off the edge of the monitor 210, then the mouse input server takes control of the mouse messages and prevents them from propagating to other systems that are running on the device.

In step 1415, the mouse messages are sent to the mouse input client on the HMD device 104 over a network connection. In step 1420, the mouse input server receives a message from the mouse input client that the cursor has transitioned to the desktop on the monitor. In step 1425 an initial cursor position on the desktop is determined based on the last reported cursor position in the virtual world. Control over the mouse messages is released in step 1430, and the cursor is enabled to be operated normally on the desktop.

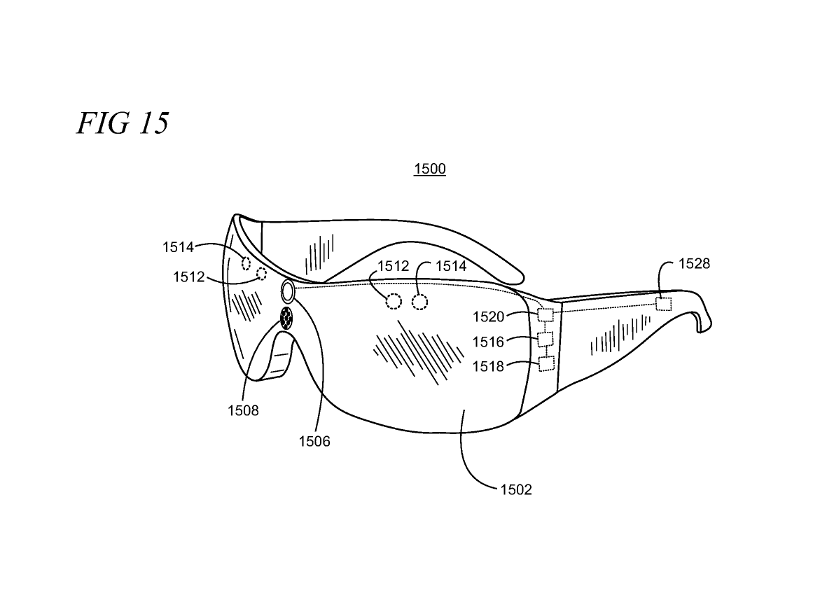

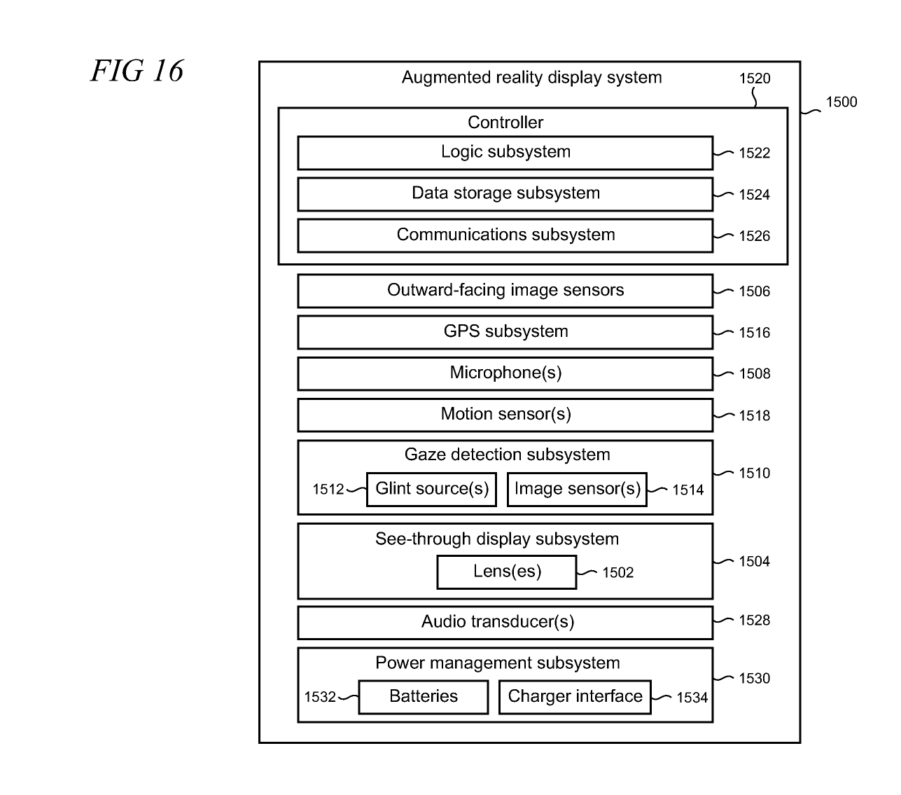

Turning now to various illustrative implementation details, a see-through, mixed reality display device according to the present arrangement may take any suitable form, including but not limited to near-eye devices such as the HMD device 104 and/or other portable/mobile devices. FIG. 15 shows one particular illustrative example of a see-through, mixed reality display system 1500, and FIG. 16 shows a functional block diagram of the system 1500. Display system 1500 comprises one or more lenses 1502 that form a part of a see-through display subsystem 1504, such that images may be displayed using lenses 1502 (e.g. using projection onto lenses 1502, one or more waveguide systems incorporated into the lenses 1502, and/or in any other suitable manner). Display system 1500 further comprises one or more outward-facing image sensors 1506 configured to acquire images of a background scene and/or physical space being viewed by a user, and may include one or more microphones 1508 configured to detect sounds, such as voice commands from a user. Outward-facing image sensors 1506 may include one or more depth sensors and/or one or more two-dimensional image sensors. In alternative arrangements, a mixed reality display system, instead of incorporating a see-through display subsystem, may display mixed reality images through a viewfinder mode for an outward-facing image sensor.

The display system 1500 may further include a gaze detection subsystem 1510 configured for detecting a direction of gaze of each eye of a user or a direction or location of focus, as described above. Gaze detection subsystem 1510 may be configured to determine gaze directions of each of a user's eyes in any suitable manner. For example, in the illustrative example shown, a gaze detection subsystem 1510 includes one or more glint sources 1512, such as infrared light sources, that are configured to cause a glint of light to reflect from each eyeball of a user, and one or more image sensors 1514, such as inward-facing sensors, that are configured to capture an image of each eyeball of the user. Changes in the glints from the user's eyeballs and/or a location of a user's pupil, as determined from image data gathered using the image sensor(s) 1514, may be used to determine a direction of gaze.

In addition, a location at which gaze lines projected from the user's eyes intersect the external display may be used to determine an object at which the user is gazing (e.g. a displayed virtual object and/or real background object). Gaze detection subsystem 1510 may have any suitable number and arrangement of light sources and image sensors. In some implementations, the gaze detection subsystem 1510 may be omitted.

The display system 1500 may also include additional sensors. For example, display system 1500 may comprise a global positioning system (GPS) subsystem 1516 to allow a location of the display system 1500 to be determined. This may help to identify real world objects, such as buildings, etc. that may be located in the user's adjoining physical environment.

The display system 1500 may further include one or more motion sensors 1518 (e.g., inertial, multi-axis gyroscopic, or acceleration sensors) to detect movement and position/orientation/pose of a user's head when the user is wearing the system as part of an augmented reality HMD device. Motion data may be used, potentially along with eye-tracking glint data and outward-facing image data, for gaze detection, as well as for image stabilization to help correct for blur in images from the outward-facing image sensor(s) 1506. The use of motion data may allow changes in gaze location to be tracked even if image data from outward-facing image sensor(s) 1506 cannot be resolved.

In addition, motion sensors 1518, as well as microphone(s) 1508 and gaze detection subsystem 1510, also may be employed as user input devices, such that a user may interact with the display system 1500 via gestures of the eye, neck and/or head, as well as via verbal commands in some cases. It may be understood that sensors illustrated in FIGS. 15 and 16 and described in the accompanying text are included for the purpose of example and are not intended to be limiting in any manner, as any other suitable sensors and/or combination of sensors may be utilized to meet the needs of a particular implementation of an augmented reality HMD device. For example, biometric sensors (e.g., for detecting heart and respiration rates, blood pressure, brain activity, body temperature, etc.) or environmental sensors (e.g., for detecting temperature, humidity, elevation, UV (ultraviolet) light levels, etc.) may be utilized in some implementations.

The display system 1500 can further include a controller 1520 having a logic subsystem 1522 and a data storage subsystem 1524 in communication with the sensors, gaze detection subsystem 1510, display subsystem 1504, and/or other components through a communications subsystem 1526. The communications subsystem 1526 can also facilitate the display system being operated in conjunction with remotely located resources, such as processing, storage, power, data, and services. That is, in some implementations, an HMD device can be operated as part of a system that can distribute resources and capabilities among different components and subsystems.

The storage subsystem 1524 may include instructions stored thereon that are executable by logic subsystem 1522, for example, to receive and interpret inputs from the sensors, to identify location and movements of a user, to identify real objects using surface reconstruction and other techniques, and dim/fade the display based on distance to objects so as to enable the objects to be seen by the user, among other tasks.

The display system 1500 is configured with one or more audio transducers 1528 (e.g., speakers, earphones, etc.) so that audio can be utilized as part of an augmented reality experience. A power management subsystem 1530 may include one or more batteries 1532 and/or protection circuit modules (PCMs) and an associated charger interface 1534 and/or remote power interface for supplying power to components in the display system 1500.

It may be appreciated that the depicted display devices 104 and 1500 are described for the purpose of example, and thus are not meant to be limiting. It is to be further understood that the display device may include additional and/or alternative sensors, cameras, microphones, input devices, output devices, etc. than those shown without departing from the scope of the present arrangement. Additionally, the physical configuration of a display device and its various sensors and subcomponents may take a variety of different forms without departing from the scope of the present arrangement.

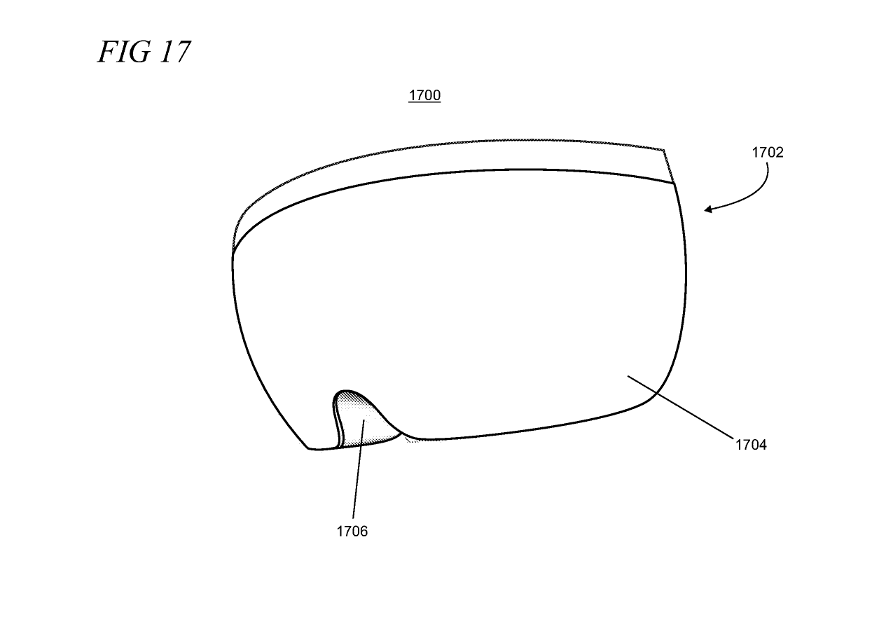

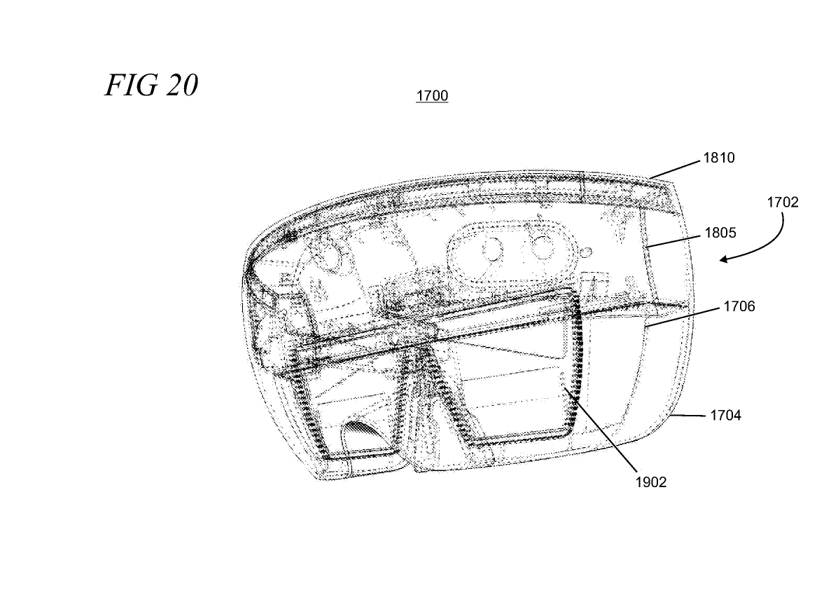

FIGS. 17-21 show an illustrative alternative implementation for an augmented reality display system 1700 that may be used as a component of an HMD device. In this example, the system 1700 uses a see-through sealed visor 1702 that is configured to protect the internal optics assembly utilized for the see-through display subsystem. The visor 1702 is typically interfaced with other components of the HMD device (not shown) such as head mounting/retention systems and other subsystems including sensors, power management, controllers, etc., as illustratively described in conjunction with FIGS. 15 and 16. Suitable interface elements (not shown) including snaps, bosses, screws and other fasteners, etc. may also be incorporated into the visor 1702.

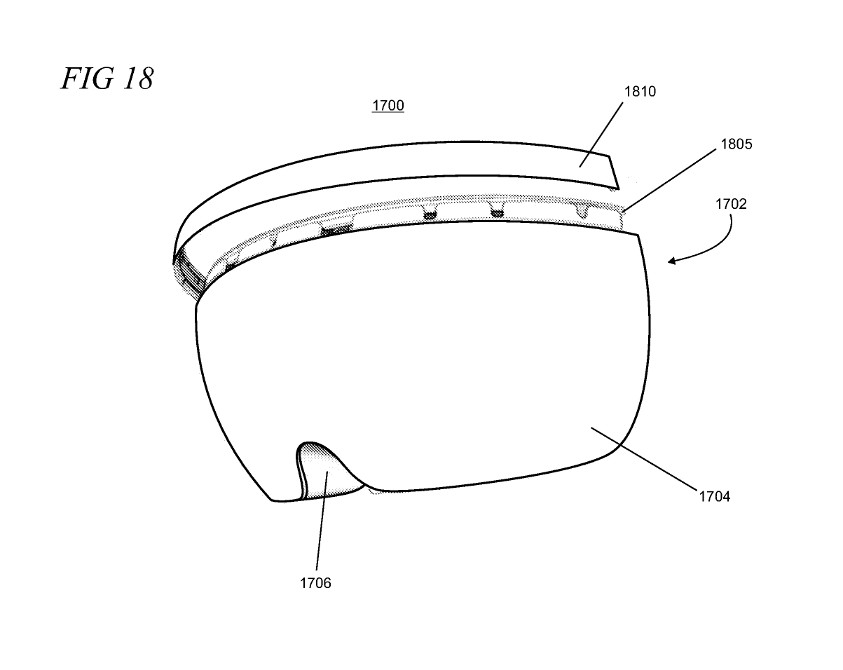

The visor includes see-through front and rear shields 1704 and 1706 respectively that can be molded using transparent materials to facilitate unobstructed vision to the optical displays and the surrounding real world environment. Treatments may be applied to the front and rear shields such as tinting, mirroring, anti-reflective, anti-fog, and other coatings, and various colors and finishes may also be utilized. The front and rear shields are affixed to a chassis 1805 as depicted in the partially exploded view in FIG. 18 in which a shield cover 1810 is shown as disassembled from the visor 1702.

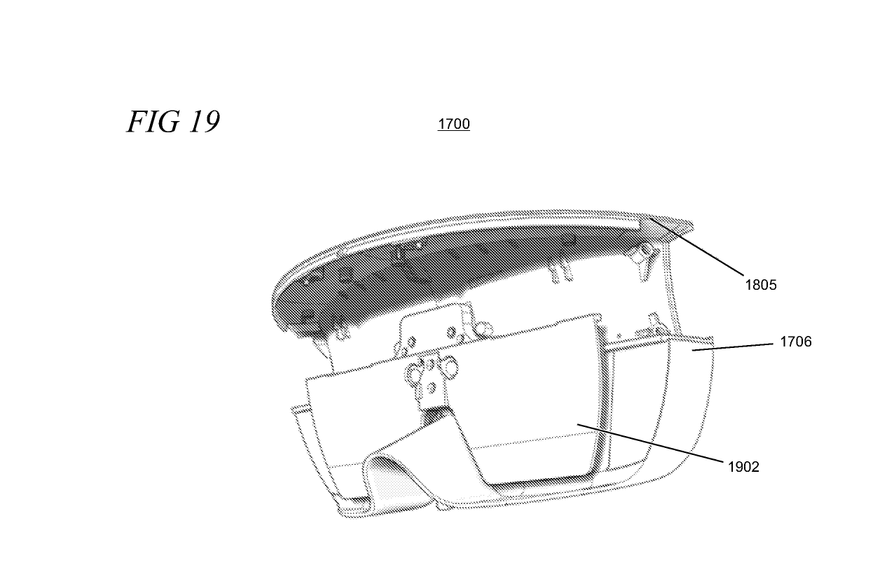

The sealed visor 1702 can physically protect sensitive internal components, including an optics display subassembly 1902 (shown in the disassembled view in FIG. 19) when the HMD device is worn and used in operation and during normal handling for cleaning and the like. The visor 1702 can also protect the optics display subassembly 1902 from environmental elements and damage should the HMD device be dropped or bumped, impacted, etc. The optics display subassembly 1902 is mounted within the sealed visor in such a way that the shields do not contact the subassembly when deflected upon drop or impact.

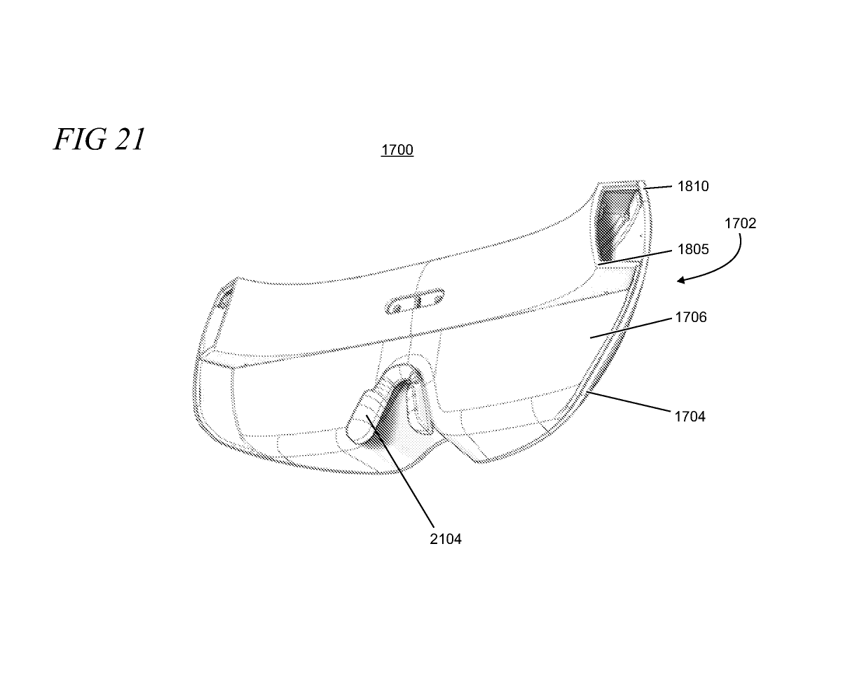

As shown in FIGS. 19 and 21, the rear shield 1706 is configured in an ergonomically correct form to interface with the user's nose and nose pads 2104 (FIG. 21) and other comfort features can be included (e.g., molded-in and/or added-on as discrete components). The sealed visor 1702 can also incorporate some level of optical diopter curvature (i.e., eye prescription) within the molded shields in some cases.

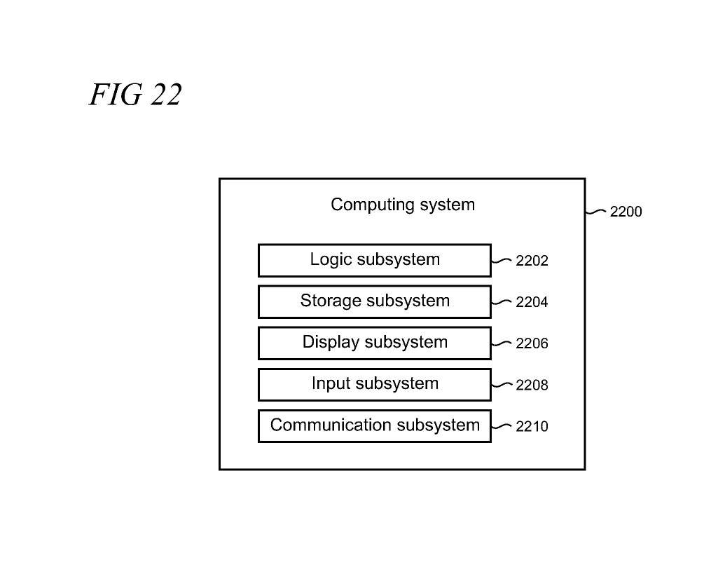

FIG. 22 schematically shows a non-limiting embodiment of a computing system 2200 that can be used when implementing one or more of the configurations, arrangements, methods, or processes described above. The HMD device 104 may be one non-limiting example of computing system 2200. The computing system 2200 is shown in simplified form. It may be understood that virtually any computer architecture may be used without departing from the scope of the present arrangement. In different embodiments, computing system 2200 may take the form of a display device, wearable computing device, mainframe computer, server computer, desktop computer, laptop computer, tablet computer, home-entertainment computer, network computing device, gaming device, mobile computing device, mobile communication device (e.g., smart phone), etc.

The computing system 2200 includes a logic subsystem 2202 and a storage subsystem 2204. The computing system 2200 may optionally include a display subsystem 2206, an input subsystem 2208, a communication subsystem 2210, and/or other components not shown in FIG. 22.

The logic subsystem 2202 includes one or more physical devices configured to execute instructions. For example, the logic subsystem 2202 may be configured to execute instructions that are part of one or more applications, services, programs, routines, libraries, objects, components, data structures, or other logical constructs. Such instructions may be implemented to perform a task, implement a data type, transform the state of one or more components, or otherwise arrive at a desired result.

The logic subsystem 2202 may include one or more processors configured to execute software instructions. Additionally or alternatively, the logic subsystem 2202 may include one or more hardware or firmware logic machines configured to execute hardware or firmware instructions. The processors of the logic subsystem 2202 may be single-core or multi-core, and the programs executed thereon may be configured for sequential, parallel, or distributed processing. The logic subsystem 2202 may optionally include individual components that are distributed among two or more devices, which can be remotely located and/or configured for coordinated processing. Aspects of the logic subsystem 2202 may be virtualized and executed by remotely accessible, networked computing devices configured in a cloud-computing configuration.

The storage subsystem 2204 includes one or more physical devices configured to hold data and/or instructions executable by the logic subsystem 2202 to implement the methods and processes described herein. When such methods and processes are implemented, the state of the storage subsystem 2204 may be transformed—for example, to hold different data.

The storage subsystem 2204 may include removable media and/or built-in devices. The storage subsystem 2204 may include optical memory devices (e.g., CD (compact disc), DVD (digital versatile disc), HD-DVD (high definition DVD), Blu-ray disc, etc.), semiconductor memory devices (e.g., RAM (random access memory), ROM (read only memory), EPROM (erasable programmable ROM), EEPROM (electrically erasable ROM), etc.) and/or magnetic memory devices (e.g., hard-disk drive, floppy-disk drive, tape drive, MRAM (magneto-resistive RAM), etc.), among others. The storage subsystem 2204 may include volatile, nonvolatile, dynamic, static, read/write, read-only, random-access, sequential-access, location-addressable, file-addressable, and/or content-addressable devices.

It may be appreciated that the storage subsystem 2204 includes one or more physical devices, and excludes propagating signals per se. However, in some implementations, aspects of the instructions described herein may be propagated by a pure signal (e.g., an electromagnetic signal, an optical signal, etc.) using a communications medium, as opposed to being stored on a storage device. Furthermore, data and/or other forms of information pertaining to the present arrangement may be propagated by a pure signal.

In some embodiments, aspects of the logic subsystem 2202 and of the storage subsystem 2204 may be integrated together into one or more hardware-logic components through which the functionality described herein may be enacted. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

When included, the display subsystem 2206 may be used to present a visual representation of data held by storage subsystem 2204. This visual representation may take the form of a graphical user interface (GUI). As the present described methods and processes change the data held by the storage subsystem, and thus transform the state of the storage subsystem, the state of the display subsystem 2206 may likewise be transformed to visually represent changes in the underlying data. The display subsystem 2206 may include one or more display devices utilizing virtually any type of technology. Such display devices may be combined with logic subsystem 2202 and/or storage subsystem 2204 in a shared enclosure in some cases, or such display devices may be peripheral display devices in others.

When included, the input subsystem 2208 may include or interface with one or more user-input devices such as a keyboard, mouse, touch screen, or game controller. In some embodiments, the input subsystem may include or interface with selected natural user input (NUI) components. Such components may be integrated or peripheral, and the transduction and/or processing of input actions may be handled on- or off-board. Exemplary NUI components may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing components for assessing brain activity.

When included, the communication subsystem 2210 may be configured to communicatively couple the computing system 2200 with one or more other computing devices. The communication subsystem 2210 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 2200 to send and/or receive messages to and/or from other devices using a network such as the Internet.

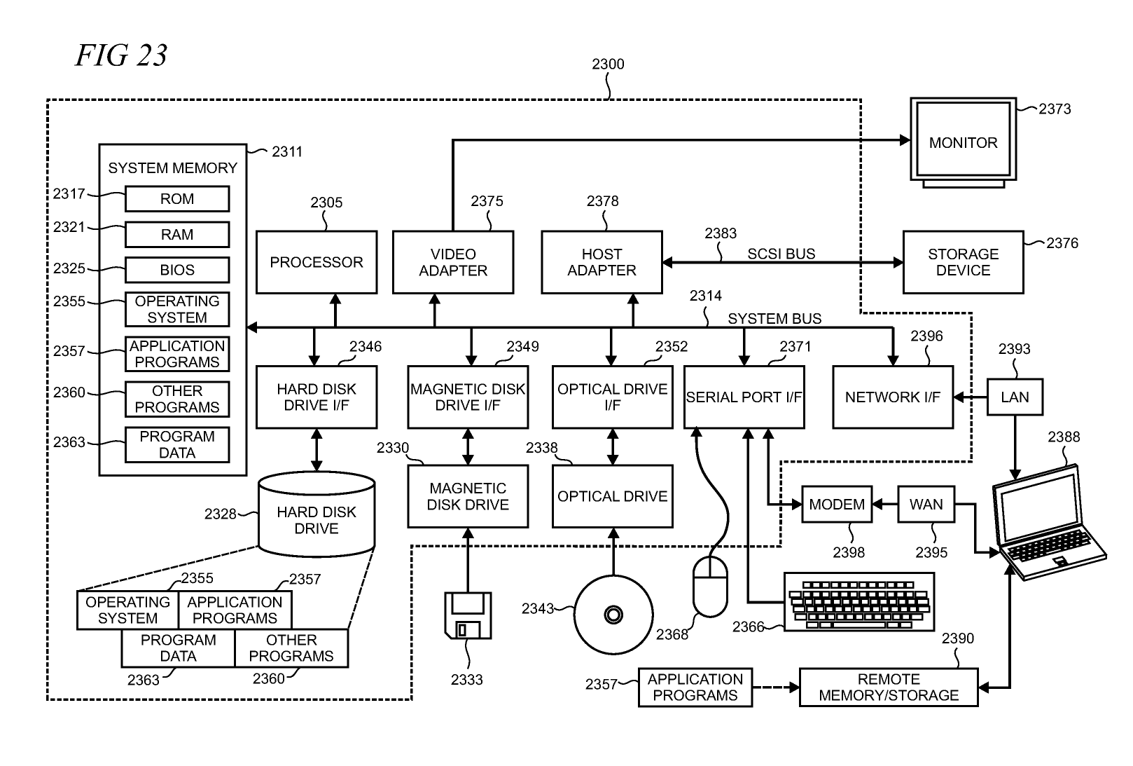

FIG. 23 is a simplified block diagram of an illustrative computer system 2300 such as a PC, client machine, or server with which the present mouse sharing may be implemented. Computer system 2300 includes a processor 2305, a system memory 2311, and a system bus 2314 that couples various system components including the system memory 2311 to the processor 2305. The system bus 2314 may be any of several types of bus structures including a memory bus or memory controller, a peripheral bus, or a local bus using any of a variety of bus architectures. The system memory 2311 includes read only memory (ROM) 2317 and random access memory (RAM) 2321. A basic input/output system (BIOS) 2325, containing the basic routines that help to transfer information between elements within the computer system 2300, such as during startup, is stored in ROM 2317. The computer system 2300 may further include a hard disk drive 2328 for reading from and writing to an internally disposed hard disk (not shown), a magnetic disk drive 2330 for reading from or writing to a removable magnetic disk 2333 (e.g., a floppy disk), and an optical disk drive 2338 for reading from or writing to a removable optical disk 2343 such as a CD (compact disc), DVD (digital versatile disc), or other optical media. The hard disk drive 2328, magnetic disk drive 2330, and optical disk drive 2338 are connected to the system bus 2314 by a hard disk drive interface 2346, a magnetic disk drive interface 2349, and an optical drive interface 2352, respectively. The drives and their associated computer-readable storage media provide non-volatile storage of computer-readable instructions, data structures, program modules, and other data for the computer system 2300. Although this illustrative example includes a hard disk, a removable magnetic disk 2333, and a removable optical disk 2343, other types of computer-readable storage media which can store data that is accessible by a computer such as magnetic cassettes, Flash memory cards, digital video disks, data cartridges, random access memories (RAMs), read only memories (ROMs), and the like may also be used in some applications of the present mouse sharing. In addition, as used herein, the term computer-readable storage media includes one or more instances of a media type (e.g., one or more magnetic disks, one or more CDs, etc.). For purposes of this specification and the claims, the phrase “computer-readable storage media” and variations thereof, does not include waves, signals, and/or other transitory and/or intangible communication media.

A number of program modules may be stored on the hard disk, magnetic disk 2333, optical disk 2343, ROM 2317, or RAM 2321, including an operating system 2355, one or more application programs 2357, other program modules 2360, and program data 2363. A user may enter commands and information into the computer system 2300 through input devices such as a keyboard 2366 and pointing device 2368 such as a mouse. Other input devices (not shown) may include a microphone, joystick, game pad, satellite dish, scanner, trackball, touchpad, touch screen, touch-sensitive device, voice-command module or device, user motion or user gesture capture device, or the like. These and other input devices are often connected to the processor 2305 through a serial port interface 2371 that is coupled to the system bus 2314, but may be connected by other interfaces, such as a parallel port, game port, or universal serial bus (USB). A monitor 2373 or other type of display device is also connected to the system bus 2314 via an interface, such as a video adapter 2375. In addition to the monitor 2373, personal computers typically include other peripheral output devices (not shown), such as speakers and printers. The illustrative example shown in FIG. 23 also includes a host adapter 2378, a Small Computer System Interface (SCSI) bus 2383, and an external storage device 2376 connected to the SCSI bus 2383.

The computer system 2300 is operable in a networked environment using logical connections to one or more remote computers, such as a remote computer 2388. The remote computer 2388 may be selected as another personal computer, a server, a router, a network PC, a peer device, or other common network node, and typically includes many or all of the elements described above relative to the computer system 2300, although only a single representative remote memory/storage device 2390 is shown in FIG. 23. The logical connections depicted in FIG. 23 include a local area network (LAN) 2393 and a wide area network (WAN) 2395. Such networking environments are often deployed, for example, in offices, enterprise-wide computer networks, intranets, and the Internet.

When used in a LAN networking environment, the computer system 2300 is connected to the local area network 2393 through a network interface or adapter 2396. When used in a WAN networking environment, the computer system 2300 typically includes a broadband modem 2398, network gateway, or other means for establishing communications over the wide area network 2395, such as the Internet. The broadband modem 2398, which may be internal or external, is connected to the system bus 2314 via a serial port interface 2371. In a networked environment, program modules related to the computer system 2300, or portions thereof, may be stored in the remote memory storage device 2390. It is noted that the network connections shown in FIG. 23 are illustrative and other means of establishing a communications link between the computers may be used depending on the specific requirements of an application of the present mouse sharing.

Various exemplary embodiments of the present mouse sharing between a desktop and a virtual world are now presented by way of illustration and not as an exhaustive list of all embodiments. An example includes a head mounted display (HMD) device operable by a user in a physical environment, comprising: one or more processors; a see-through display configured for rendering a mixed reality environment to the user, a view position of the user for the rendered mixed reality environment being variable depending at least in part on a pose of the user's head in the physical environment; and one or more memory devices storing computer-readable instructions which, when executed by the one or more processors, perform a method comprising the steps of: rendering the mixed reality environment within a field of view of the HMD device, the mixed reality environment including objects supported in a virtual world and objects supported in a real world, receiving mouse messages over a network connection from a mouse input server running on a remote computing device, the mouse messages describing movements of a mouse that is operatively connected to the computing device, the mouse controlling a cursor displayable in the virtual world and on a monitor in the real world, when movement of the mouse causes the cursor to move beyond a border of the monitor, calculating an initial position of the cursor in the virtual world, using the mouse messages to calculate subsequent positions of the cursor in the virtual world, and rendering the cursor in the virtual world using the calculated initial and subsequent positions.

In another example, the HMD further includes determining deltas between mouse movements from the mouse messages and using the deltas to calculate a subsequent position for the cursor in the virtual world. In another example, the HMD further includes receiving button push events in the mouse messages, and using the button push events as inputs when rendering the mixed reality environment. In another example, the HMD further includes obtaining sensor data describing a physical space adjoining a user of the HMD device; using the sensor data, reconstructing a geometry of the physical space; and tracking the user's head in the physical space using the reconstructed geometry to determine the view position. In another example, the sensor data includes depth data and the HMD further includes generating the sensor data using a depth sensor and applying surface reconstruction techniques to reconstruct the physical space geometry. In another example, the HMD further includes determining if the cursor is transitioning to the desktop by calculating a ray between the next position of the cursor and the view position and, if the ray intersects the real world monitor, informing the computing device that the cursor has transitioned to a desktop supported on the monitor. In another example, the HMD further includes discontinuing the rendering of the cursor in the virtual world when the cursor has transitioned to the desktop. In another example, the HMD further includes a network interface over which the mouse messages are communicated from the computing device and over which the computing device is informed that the cursor has transitioned to the desktop. In another example, the HMD further includes enabling an object to be moved from the desktop to the virtual world using the mouse. In another example, the HMD further includes a sensor package for detecting a gaze direction of the user when determining the view position. In another example, the HMD further includes enabling interactions with one or more virtual objects using the cursor. In another example, the HMD further includes enabling collisions between the cursor and real world objects.

A further example includes a method for communicating mouse information between a computing device and an application executing on a head mounted display (HMD) device, the application supporting a mixed reality environment on the HMD device including a virtual world and a real world, the method comprising: operating a mouse input client in the application; receiving mouse messages over a network connection from a mouse input server executing on the computing device, the mouse messages describing movements of a mouse that is operatively coupled to the computing device having an associated monitor, the mouse input server sending the mouse messages when a movement of the mouse causes a mouse cursor to move past an edge of the monitor to exit the real world and enter the virtual world; determining an initial position of the mouse cursor in the virtual world using a position of exit from the real world; and utilizing movements of the mouse to determine subsequent mouse cursor positions in the virtual world.

In another example, the method further includes rendering the mouse cursor in the virtual world at the initial position and at the subsequent mouse cursor positions on the HMD device. In another example, the method further includes utilizing sensor data to determine a view position of a user of the HMD device and transitioning the cursor back to a desktop supported by the monitor when a ray projected from the view position intersects the monitor. In another example, the method further includes modeling a physical environment in which the HMD device is located using a surface reconstruction data pipeline that implements a volumetric method creating multiple overlapping surfaces that are integrated and using the modeled physical environment at least in part to determine the view position.

A further example includes a computing device, comprising: one or more processors; an interface to a monitor, the monitor displaying a desktop; a mouse interface for connecting to a mouse and receiving signals from the mouse indicating mouse movement and inputs to mouse controls from a user of the computing device; a network interface for communicating with a remote head mounted display (HMD) device over a network connection; and one or more memory devices storing computer-readable instructions which, when executed by the one or more processors implement a mouse input server configured for tracking mouse messages that describe the mouse movements and inputs, when a mouse movement indicates that a cursor associated with the mouse is moving beyond and edge of the monitor, taking control of the mouse messages and preventing propagation of the mouse messages to systems operating on the computing device, and sending the mouse messages to the HMD device over the network connection.

In another example, the HMD device is configured for rendering a mixed reality environment on an optical display, the mixed reality environment including objects in a virtual world and objects in a real world, the mouse messages being utilized by the HMD device to at least render the cursor in the virtual world. In another example, the computing device further includes tracking the mouse messages by interacting with an operating system executing on the computing device. In another example, the computing device further includes receiving a message from the HMD device that the mouse cursor has transitioned to the desktop and calculating an initial cursor position on the desktop using a last reported position of the mouse cursor in the virtual world.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A head mounted display (HMD) device operable by a user in a physical environment, comprising:
one or more processors;
a see-through display configured for rendering a mixed reality environment to the user, a view position of the user for the rendered mixed reality environment being variable depending at least in part on a pose of the user's head in the physical environment; and
one or more memory devices storing computer-readable instructions which, when executed by the one or more processors, perform a method comprising the steps of:
rendering the mixed reality environment within a field of view of the HMD device, the mixed reality environment including objects supported in a virtual world and objects supported in a real world,
receiving mouse messages over a network connection from a mouse input server running on a remote computing device, the mouse messages describing movements of a mouse that is operatively connected to the computing device, the mouse controlling a cursor displayable in the virtual world and on a monitor in the real world,
when movement of the mouse causes the cursor to move beyond a border of the monitor, calculating an initial position of the cursor in the virtual world,
using the mouse messages to calculate subsequent positions of the cursor in the virtual world, and
rendering the cursor in the virtual world using the calculated initial and subsequent positions.

2. The HMD of claim 1 further including determining deltas between mouse movements from the mouse messages and using the deltas to calculate a subsequent position for the cursor in the virtual world.

3. The HMD of claim 1 further including receiving button push events in the mouse messages, and using the button push events as inputs when rendering the mixed reality environment.

4. The HMD of claim 1 further including
obtaining sensor data describing a physical space adjoining a user of the HMD device;
using the sensor data, reconstructing a geometry of the physical space; and
tracking the user's head in the physical space using the reconstructed geometry to determine the view position.

5. The HMD of claim 4 in which the sensor data includes depth data and further including generating the sensor data using a depth sensor and applying surface reconstruction techniques to reconstruct the physical space geometry.

6. The HMD of claim 4 further including determining if the cursor is transitioning to the desktop by calculating a ray between the next position of the cursor and the view position and, if the ray intersects the real world monitor, informing the computing device that the cursor has transitioned to a desktop supported on the monitor.

7. The HMD of claim 6 further including discontinuing the rendering of the cursor in the virtual world when the cursor has transitioned to the desktop.

8. The HMD of claim 6 further including a network interface over which the mouse messages are communicated from the computing device and over which the computing device is informed that the cursor has transitioned to the desktop.

9. The HMD of claim 6 further including enabling an object to be moved from the desktop to the virtual world using the mouse.

10. The HMD of claim 1 further including a sensor package for detecting a gaze direction of the user when determining the view position.

11. The HMD of claim 1 further including enabling interactions with one or more virtual objects using the cursor.

12. The HMD of claim 1 further including enabling collisions between the cursor and real world objects.

13. A method for communicating mouse information between a computing device and an application executing on a head mounted display (HMD) device, the application supporting a mixed reality environment on the HMD device including a virtual world and a real world, the method comprising:
operating a mouse input client in the application;
receiving mouse messages over a network connection from a mouse input server executing on the computing device, the mouse messages describing movements of a mouse that is operatively coupled to the computing device having an associated monitor, the mouse input server sending the mouse messages when a movement of the mouse causes a mouse cursor to move past an edge of the monitor to exit the real world and enter the virtual world;
determining an initial position of the mouse cursor in the virtual world using a position of exit from the real world; and
utilizing movements of the mouse to determine subsequent mouse cursor positions in the virtual world.

14. The method of claim 13 further including rendering the mouse cursor in the virtual world at the initial position and at the subsequent mouse cursor positions on the HMD device.

15. The method of claim 13 further including utilizing sensor data to determine a view position of a user of the HMD device and transitioning the cursor back to a desktop supported by the monitor when a ray projected from the view position intersects the monitor.

16. The method of claim 15 further including modeling a physical environment in which the HMD device is located using a surface reconstruction data pipeline that implements a volumetric method creating multiple overlapping surfaces that are integrated and using the modeled physical environment at least in part to determine the view position.

17. A computing device, comprising:
one or more processors;
an interface to a monitor, the monitor displaying a desktop;
a mouse interface for connecting to a mouse and receiving signals from the mouse indicating mouse movement and inputs to mouse controls from a user of the computing device;
a network interface for communicating with a remote head mounted display (HMD) device over a network connection; and
one or more memory devices storing computer-readable instructions which, when executed by the one or more processors implement a mouse input server configured for
tracking mouse messages that describe the mouse movements and inputs,
when a mouse movement indicates that a cursor associated with the mouse is moving beyond and edge of the monitor, taking control of the mouse messages and preventing propagation of the mouse messages to systems operating on the computing device, and
sending the mouse messages to the HMD device over the network connection.

18. The computing device of claim 17 in which the HMD device is configured for rendering a mixed reality environment on an optical display, the mixed reality environment including objects in a virtual world and objects in a real world, the mouse messages being utilized by the HMD device to at least render the cursor in the virtual world.

19. The computing device of claim 17 further including tracking the mouse messages by interacting with an operating system executing on the computing device.

20. The computing device of claim 17 further including receiving a message from the HMD device that the mouse cursor has transitioned to the desktop and calculating an initial cursor position on the desktop using a last reported position of the mouse cursor in the virtual world.
